(19) United States
(12) Patent Application Publication
(10) Pub. No.: US 2006/0184640 A1
(43) Pub. Date: Aug. 17, 2006

(54) Method and apparatus for processing a website request

(76) Inventor: Ryan D. Hatch, Green Bay, WI (US)

Correspondence Address: FOLEY & LARDNER LLP, 777 EAST WISCONSIN AVENUE, SUITE 3800, MILWAUKEE, WI, 53202-5308, US

(21) Appl. No.: 11/058,565

(22) Filed: Feb. 15, 2005

(51) Int. Cl. G06F 15/16

(52) U.S. Cl. 709/217

(57) ABSTRACT

A method includes receiving a request from a client device regarding a website, wherein the request is received by a network device in communication with the client device via a LAN, transmitting the request to a server associated with the website, receiving a web page from the server, modifying the web page to include additional content associated with an approximate geographic area having access to the LAN, and transmitting the modified web page to the client device. Another method includes receiving a DNS request associated with a request regarding a first website from a client device, wherein the request is received by a DNS server in communication with the client device via a LAN, redirecting the request to a server associated with a second website different from the first website, wherein the DNS server is configured to respond to all DNS requests by transmitting the IP address for the server associated with the second website, and transmitting a web page from the second website to the client device.

### FIELD

The present invention relates generally to a method and apparatus for processing website requests, and more particularly to a method and apparatus for processing website requests in order to provide local geographical management of web page content.

### BACKGROUND

The Internet provides electronic communication among computer networks and users worldwide. Through the Internet, entities such as businesses, governments, organizations, and individuals can provide users with access to information and advertisements on a nationwide or even an international scale. For example, by placing advertisements on various websites on the Internet, or by utilizing a search service from an Internet search engine company to link advertisements with particular search terms entered by a user, businesses may be able to increase revenues by reaching a larger audience for their products and services.

While the Internet provides an effective communication medium for entities seeking to reach a larger number or broader range of users over an expanded geographical range, it may be less effective for entities seeking to reach users in a particular local market or in a limited geographical area. For example, currently, many Internet advertisements are placed on a website-by-website basis depending on the type of product, service, or targeted user demographic (e.g., by creating a dedicated website or web page for an automobile, or by placing an advertisement for the automobile on the website of a popular auto trade publication). Many other advertisements are placed with an Internet search engine company to link the advertisements with particular search terms entered by a user. While these methods of advertising may be effective for targeting large numbers of users nationwide or worldwide based on a particular type of subject matter or anticipated class of user, they may be less effective in allowing users to be targeted on a localized geographical basis. Further, while computers or other electronic devices communicating via the Internet are assigned an Internet Protocol (IP) address that may be used for tracking purposes, many IP addresses provide no information as to the actual geographical location of the computer and user. Thus, there is need for a method and apparatus for processing website requests that provides local geographical management of web page content such that entities may provide information and advertisements to users based on a particular geographic location of the user.

### SUMMARY

According to an exemplary embodiment, a method includes receiving an electronic website request regarding a website, wherein the website request is received by a network device in communication with a Local Area Network (LAN) from a client device in communication with the LAN. The method also includes transmitting the website request from the network device to a server associated with the website, and receiving a web page from the server associated with the website in response to the website request, wherein the web page is received by the network device. The method further includes modifying the web page within the network device to include additional content associated with an approximate geographic area having access to the LAN, and transmitting the modified web page from the network device to the client device.

According to another exemplary embodiment, a method includes receiving a Domain Name System (DNS) request associated with an electronic website request regarding a first website. The DNS request is received by a DNS server in communication with a Local Area Network (LAN) from a client device in communication with the LAN. The method also includes redirecting the website request to a server associated with a second website different from the first website by transmitting an Internet Protocol (IP) address for the server associated with the second website from the DNS server to the client device in response to the DNS request. The DNS server is configured to respond to all DNS requests by transmitting the IP address for the server associated with the second website. The method also includes transmitting a web page included in the second website from the server associated with the second website to the client device in response to the redirected website request.

According to another exemplary embodiment, a network device configured to process an electronic request regarding a website includes means for receiving the electronic request regarding the website from a client device in communication with a Local Area Network (LAN). The network device is in communication with the LAN. The network device also includes means for transmitting the request to a server associated with the website, means for receiving a web page from the server associated with the website in response to the request, means for modifying the web page to include additional content associated with an approximate geographic area having access to the LAN, and means for transmitting the modified web page to the client device.

According to another exemplary embodiment, a Domain Name System (DNS) server configured to process an electronic request regarding a website includes means for receiving a DNS request associated with an electronic website request regarding a first website. The DNS request is received from a client device in communication with the DNS server via a LAN. The DNS server also includes means for redirecting the website request to a server associated with a second website different from the first website by transmitting an Internet Protocol (IP) address for the server associated with the second website from the DNS server to the client device in response to the DNS request. The DNS server is configured to respond to all DNS requests by transmitting the IP address for the server associated with the second website.

According to another exemplary embodiment, a method includes receiving an electronic website request regarding a first website. The website request is received by a network device in communication with a Local Area Network (LAN) from a client device in communication with the LAN. The method also includes redirecting the website request to a server associated with a second website different from the first website. The network device is configured to redirect all website requests to the server associated with the second website. The method also includes transmitting a web page included in the second website from the server associated with the second website to the client device in response to the redirected website request. The content of the web page includes content associated with an approximate geographic area having access to the LAN.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### BRIEF DESCRIPTION OF THE DRAWINGS

The exemplary embodiments will hereafter be described with reference to the accompanying drawings, wherein like numerals depict like elements, and:

FIG. 1 is a diagram illustrating a system in which a method of processing a website request may be implemented according to an exemplary embodiment;

FIG. 2 is a flow diagram illustrating a method of processing a website request using the system of FIG. 1 according to an exemplary embodiment;

FIG. 3 illustrates the content of a web page before modification using the method of FIG. 2 to add additional content according to an exemplary embodiment;

FIG. 4 illustrates the content of the web page of FIG. 3 after modification using the method of FIG. 2 to add additional content according to an exemplary embodiment;

FIG. 5 is a diagram illustrating a system in which a method of processing a website request may be implemented according to another exemplary embodiment;

FIG. 6 is a flow diagram illustrating a method of processing a website request using the system of FIG. 5 according to an exemplary embodiment;

FIG. 7 illustrates the content of a web page corresponding to a requested website before using the method of FIG. 6 to process the website request according to an exemplary embodiment;

FIG. 8 illustrates the content of an alternate web page provided in response to the web request after using the method of FIG. 6 to process the website request according to an exemplary embodiment;

FIG. 9 is a diagram illustrating a system which is an embodiment of the system of FIG. 5 and in which exemplary methods of processing a website request may be implemented;

FIG. 10 is a flow diagram illustrating a method of processing a website request using the system of FIG. 9 according to an exemplary embodiment;

FIG. 11 is a flow diagram illustrating a method of processing a website request using the system of FIG. 9 according to another exemplary embodiment; and

FIG. 12 is a flow diagram illustrating a method of processing a website request using the system of FIG. 9 according to another exemplary embodiment.

### DETAILED DESCRIPTION

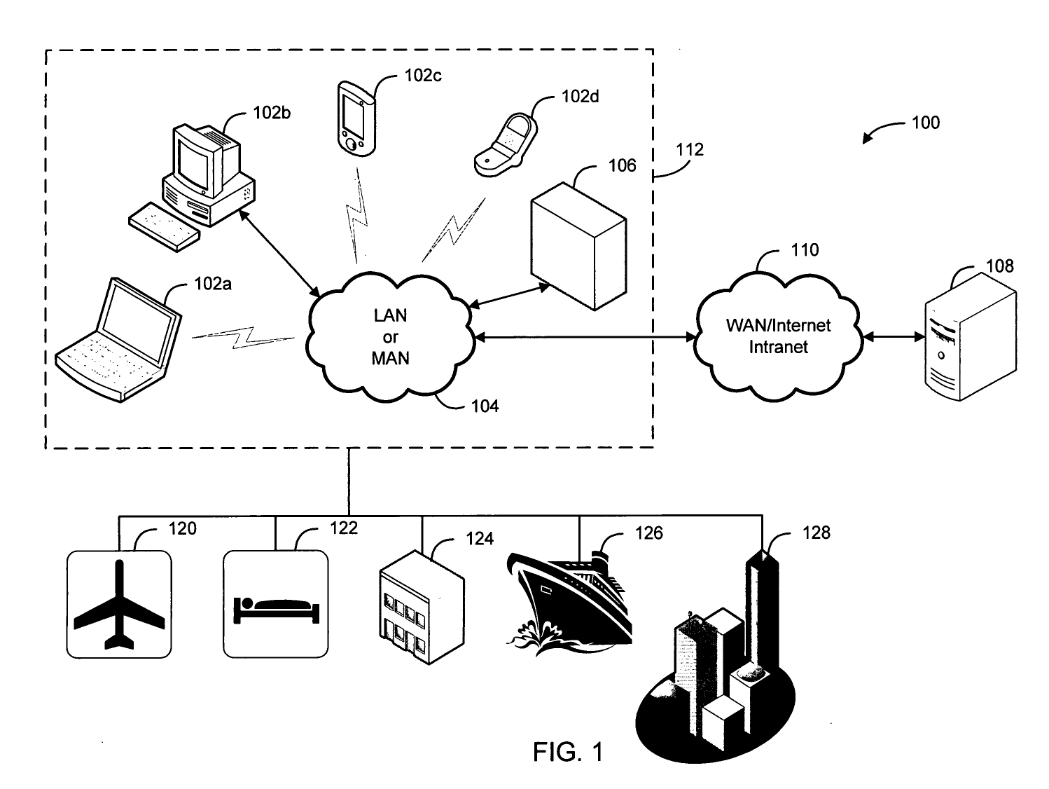

FIG. 1 is a diagram illustrating a system 100 in which a method of processing a website request may be implemented according to an exemplary embodiment. In system 100, one or more client devices 102 are in communication with a Local Area Network (LAN) 104 and a network device 106. Network device 106 is also in communication with a server 108 via a network 110. System 100 is generally configured to process website requests from a client device 102 in communication with network device 106 via LAN 104, and to transmit web pages from server 108 to the client device 102 in response to the website request. More particularly, system 100 is configured to modify web pages received from server 108 within network device 106 to include additional content, and to transmit the modified web page from network device 106 to the client device 102. The term content as used herein generally refers to any data being returned to client device 102 in association with the website request.

Client device 102 may be one of several types of microprocessor-based devices configured for communication with network device 106 via LAN 104 and having appropriate display capabilities. For example, client device 102 may be a laptop computer 102a, a desktop computer 102b, a handheld computer 102c (e.g., a “Personal Digital Assistant” or “PDA”), a cellular telephone 102d having a suitable display, or the like. According to an exemplary embodiment, client device 102 utilizes an AMD Thunderbird 800 Megahertz microprocessor, Windows XP Professional, and is Dynamic Host Configuration Protocol (DHCP) enabled.

Client device 102 may be configured to communicate with LAN 104 using a wired or wireless communication connection. For example, in FIG. 1, laptop computer 102a, handheld computer 102c, and cellular telephone 102d are illustrated as being in communication with LAN 104 via a wireless connection, while desktop computer 102b is illustrated as being in communication with LAN 104 via a wired connection. Exemplary communication mediums for communication with LAN 104 include telephone line or “dial-up” connections, cable, Digital Subscriber Line (DSL), Ethernet, Wireless High-Fidelity (i.e., “Wi-Fi” or IEEE standard 802.11), or the like.

Client device 102 may be configured to communicate with network device 106 via LAN 104 using one of several types of communications protocols and/or formats. Preferably, system 100 is configured such that client device 102 communicates website requests to network device 106 via LAN 104 using a Hypertext Transfer Protocol (HTTP) and suitable Internet browser software (e.g., Internet Explorer, Opera, Firefox, etc.), which may also be utilized to facilitate viewing web pages received by client device 102. Client device 102 may be configured to establish communication with LAN 104 using any suitable technique. For example, client device 102 may be configured to establish communication with LAN 104 by sending a DHCP request to a DHCP server associated with LAN 104, wherein the DHCP server is configured to respond to the DHCP request with various IP addresses for devices associated with LAN 104, such as the IP addresses for client device 102, a network submask associated with the LAN, a DNS server associated with the LAN, a gateway associated with the LAN, etc.

LAN 104 is generally configured to facilitate communication between client device 102 and network device 106. More particularly, LAN 104 is configured to facilitate the transmission of electronic website requests from client device 102 to network device 106, and the transmission of web pages received by network device 106 from server 108 to client device 102 in response to the website request. The term “website request” as used herein refers to an electronic website request, such as an HTTP request for a particular web server hosting the website, comprising a Universal Resource Locator (URL) transmitted by a client device over a network or other connection for processing so that a host server for the website may return data in response to the request. In a typical website request process, one or more host servers are waiting for electronic website requests from a client device. The client device attempts to connect to one of the host servers using the Internet Protocol (IP) address and port address for the server. The IP address for the server is obtained through the process of domain name resolution, wherein the client device sends a Domain Name System (DNS) request associated with the website request to a DNS server to translate the domain name for the requested website to the IP address for the host server for the website. The IP address may then be cached in the client device so that domain name resolution is not necessary each time the website is requested by the client device. The port address for the server is typically known by the client device prior to attempting to connect to the host server. For example, a typical HTTP server implementation may operate on port address 80. Once the host server accepts the connection, the client device completes the web request to the host server, and the host server responds to the website request with data for the requested URL.

According to an exemplary embodiment, LAN 104 is configured to facilitate the transmission of electronic website requests from client device 102 to network device 106, and the transmission of web pages received by network device 106 from server 108 to client device 102 in response to the website request when client device 102 initiates a website request. According to another exemplary embodiment, LAN 104 is configured to facilitate the transmission of electronic website requests from client device 102 to network device 106, and the transmission of web pages received by network device 106 from server 108 to client device 102 in response to the website request when client device 102 is in authorized communication with LAN 104. The term “authorized communication” refers to communication between client device 102 and LAN 104 once client device 102 has received access to the LAN after completing an authentication process, such as a “login” transaction requiring a user identification and/or password. In an exemplary authentication process, client device 102 may establish a connection with LAN 104 (e.g., a wireless connection) and initiate a website request. Client device 102 may then receive an authentication or login screen or webpage via LAN 104 requiring entry of a user identification, password, or other information. Once this information is provided, client device 102 may transmit this information via LAN 104 for authentication. Once the information provided by client device 102 is authenticated, client device 102 is in authorized communication with LAN 104.

Access to LAN 104 is limited to an approximate geographic area 112 that is relatively smaller in size, as opposed to a Wide Area Network (WAN) that links two or more networks to cover a large geographic area (e.g., the Internet or World Wide Web or another network linking several cities, states, countries, etc.). For example, according to various exemplary embodiments, LAN 104 may be accessible to users in the approximate geographic area of an entity such as an airport 120, a hotel 122, a business, university or organizational facility 124, a cruise ship 126, or the like. According to various other embodiments, LAN 104 may be interconnected with one or more additional LANs to form a Metropolitan Area Network (MAN) providing access to a town or city 128.

Network device 106 may be one of several types of network devices. For example, according to an exemplary embodiment, network device 106 is a LAN gateway configured to implement a “transparent proxy.” According to various other embodiments, network device 106 is a router, a bridge, or a similar device that may be used to receive and transmit LAN communications. An exemplary configuration for network device 106 is as follows:

Compaq DeskPro EN ATX Desktop computer;

RedHat Linux 7.2 Server;

Squid Cache Proxy 2.4 STABLE1;

Privoxy 3.0.3;

Transparent Proxy on Port 80;

Network Card 1: Internet;

Network Card 2: Network Address Translation, DHCP Server

Network Device 106 is generally configured to receive and process website requests from client device 102 via LAN 104, to transmit the website request to server 108, and to transmit web pages received from server 108 to the client device 102 in response to the website request. Server 108 is a host server associated with the website which includes information in the form of one or more web pages. Server 108 is in communication with network device 106 via network 110. Network 110 may be of any suitable configuration to connect server 108 with network device 106. According to an exemplary embodiment, network 110 is a WAN such as the Internet or an Intranet.

Network device 106 is also configured to modify web pages received from server 108 to include additional content, and to transmit the modified web page from network device 106 to the client device 102. According to an exemplary embodiment, network device 106 utilizes a proxy, such as Privoxy, to modify web pages received from server 108 to include the additional content. An exemplary Privoxy configuration for network device 106 is as follows:

| config | |
|---|---|
| ... | |
| #actionsfile standard | # Internal purpose, recommended |
| #actionsfile default | # Default stuff |
| #actionsfile user | # User customizations |
| #actionsfile adserver | # AdServer customizations |

adserver.action
{ +filter{adserver} }
.*
adserver.filter
FILTER: adserver Add Text at Beginning of Document
s|(<BODY[\hat{ }>]*)>|$1>\n\n<CENTER><IFRAME
SRC=http://www.websitename.com/adserver/adserver.cgi
WIDTH=800
HEIGHT=100 SCROLLING=NO FRAMEBORDER=0
MARGINWIDTH=0
MARGINHEIGHT=0>AdServer
Advertisement</IFRAME><BR><FONT
SIZE=1 ALIGN=CENTER>You are on the Adserver
Network</CENTER></FONT><BR><HR SIZE=1
WIDTH=100%>\n\n|Uisg

The additional content provided by network device 106 includes additional information, an advertisement, or the like, that is associated with the approximate geographic area 112 having access to LAN 104. For example, the additional content may be information or an advertisement provided by an entity located in approximate geographic area 112. According to an exemplary embodiment, LAN 104 is accessible to users in the approximate geographic area 112 of airport 120, and network device 106 is configured to modify web pages received from server 108 to include advertisements targeted to users of LAN 104, such as advertisements for in-house restaurants and bars, car rental agencies, bookstores, local hotels, and local transportation services.

According to another exemplary embodiment, LAN 104 is accessible to users in the approximate geographic area 112 of hotel 122, and network device 106 is configured to modify web pages received from server 108 to include advertisements for internal hotel services, or local restaurants and attractions.

According to another exemplary embodiment, LAN 104 is accessible to users in the approximate geographic area 112 of an organization, business or entity 124 providing products or services (e.g., a bookstore, coffee shop, shopping mall, etc.), and network device 106 is configured to modify web pages received from server 108 to include advertisements for the particular business, product, or service (e.g., ads from publishers or individual shops in a mall). Network device 106 may also be configured to modify web pages received from server 108 to include messaging or announcements to employees, departments, or to the entire business or organization.

According to another exemplary embodiment, LAN 104 is accessible to users in the approximate geographic area 112 of cruise ship 126, and network device 106 is configured to modify web pages received from server 108 to include information on the ship's position, course, speed, and next ports of call, as well as information regarding internal attractions on the ship, such as theater performances, restaurants, internal shops, and casinos.

According to various other embodiments, LAN 104 is interconnected with one or more additional LANs to form a MAN providing access to a town or city 128, and network device 106 is configured to modify web pages received from server 108 to include information or advertisements for various entities located citywide.

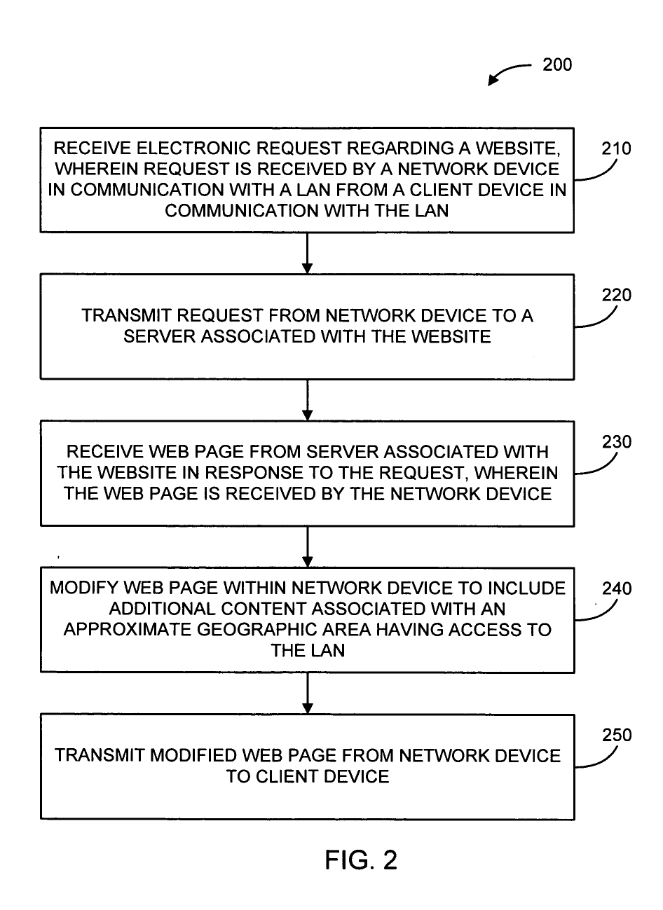

FIG. 2 is a flow diagram illustrating a method 200 of processing a website request using system 100 according to an exemplary embodiment. Method 200 begins with a step 210. In step 210, an electronic request regarding a website is received by network device 106 from client device 102 via LAN 104. In a step 220, the electronic request regarding the website is transmitted from network device 106 to server 108 associated with the requested website. In a step 230, a web page transmitted from server 108 in response to the electronic website request is received by network device 106. In a step 240, the web page is modified within network device 106 to include additional content associated with an approximate geographic area 112 having access to the LAN. In a step 250, the modified web page is transmitted from network device 106 to client device 102 via LAN 104.

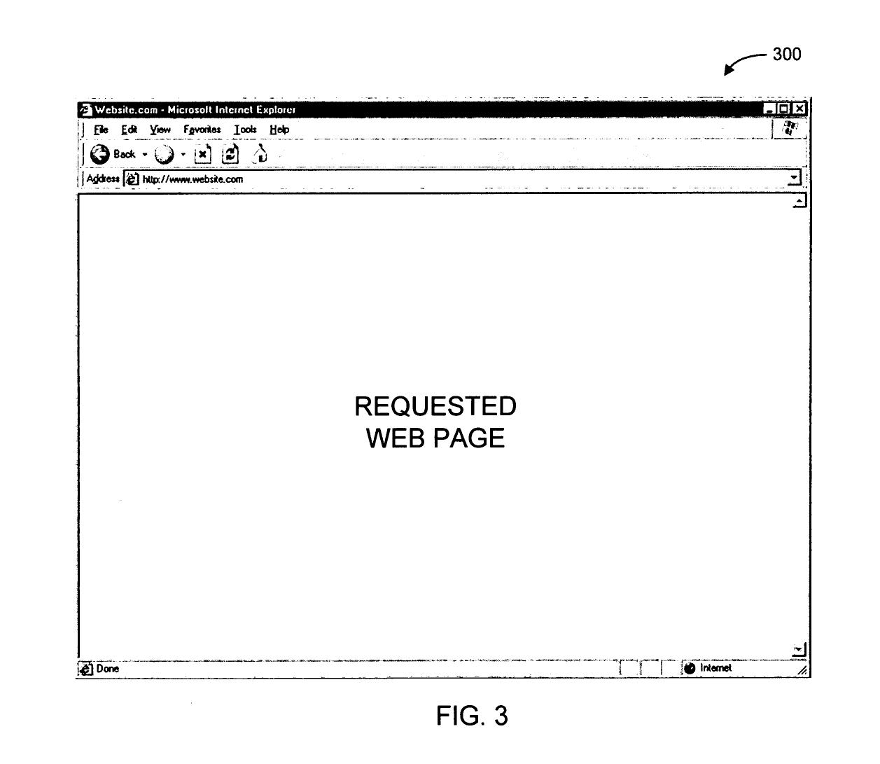

FIG. 3 illustrates the content of a web page 300 before modification by network device 106 (shown in FIG. 1) to include additional content according to an exemplary embodiment. The only web page content included in web page 300 is that which was provided by server 108 in response to the electronic website request.

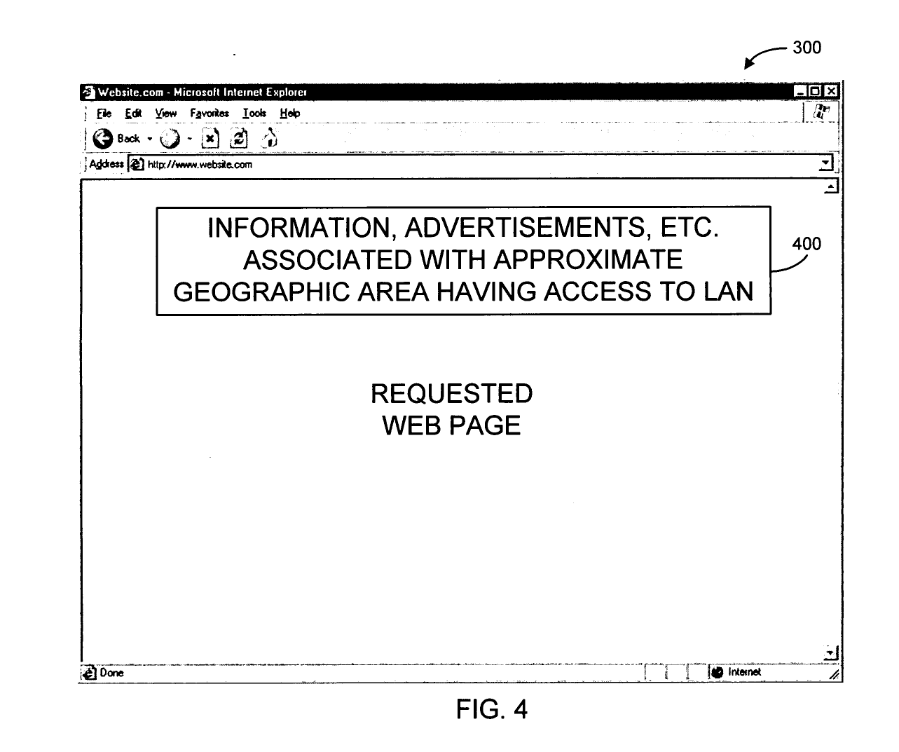

FIG. 4 illustrates the content of web page 300 after modification by network device 106 (shown in FIG. 1) to include additional content according to an exemplary embodiment. As shown in FIG. 4, web page 300 has been modified by network device 106 such that, in addition to the web page content provided by server 108 in response to the electronic website request, additional content 400 has been added (e.g., additional information, advertisements, etc.). The additional content is associated with an approximate geographic area 112 having access to LAN 104 (shown in FIG. 1).

In this way, the method and apparatus for processing a website request provides local geographical management of web page content. Entities such as local businesses, governments, organizations, individuals, etc. may post information or advertisements on LAN 104 using network device 106 such that when users of client device 102 access network 110 (e.g., the Internet) via LAN 104, local information, advertisements, etc. are returned whenever a user requests a web page from a website over network 110. Because users of LAN 104 are physically located in an approximate geographic area having access to LAN 104, these entities may target information, advertisements, etc. to the particular local market or limited geographic area.

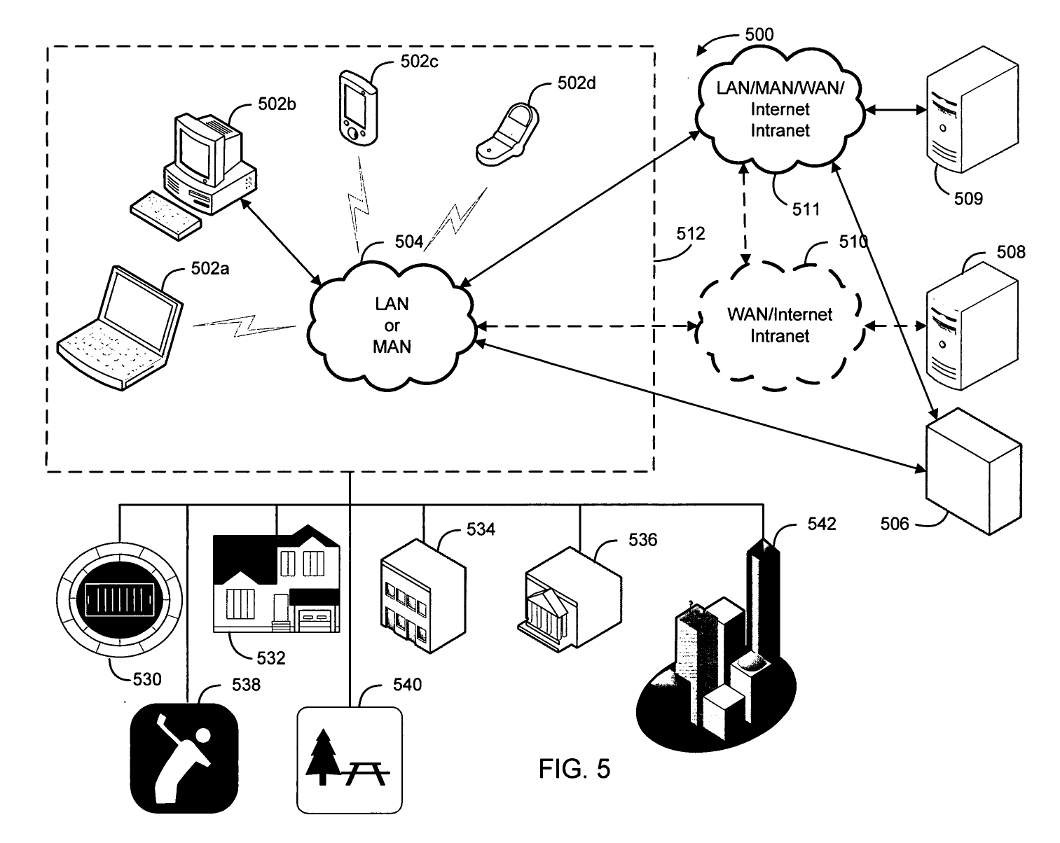

FIG. 5 is a diagram illustrating a system 500 in which a method of processing a website request may be implemented according to another exemplary embodiment. In system 500, one or more client devices 502 are in communication with a network device 506 via a LAN 504. LAN 504 is also optionally in communication with server 508 via network 510, and is in communication with server 509 via network 511. System 500 is generally configured to receive a DNS request associated with a website request for server 508 from a client device 502 in communication with network device 506 via LAN 504, and to transmit a web page from server 509 to the client device 502 in response to the website request. More particularly, system 500 is configured to redirect the website request to server 509 by responding to the associated DNS request with the IP address of server 509 rather than server 508, and to transmit a web page from server 509 to the client device 502 in response to the website request.

As with client device 102 (shown in FIG. 1), client device 502 may be one of several types of microprocessor-based devices configured for communication with network device 506 via LAN 504 and having appropriate display capabilities. For example, client device 502 may be a laptop computer 502a, a desktop computer 502b, a handheld computer 502c (e.g., a PDA), a cellular telephone 502d having a suitable display, or the like. According to an exemplary embodiment, client device 502 utilizes an AMD Thunderbird 800 Megahertz microprocessor, Windows XP Professional, and is DHCP enabled.

As with client device 102, client device 502 may be configured to communicate with LAN 504 using a wired or wireless communication connection. For example, in FIG. 5, laptop computer 502a, handheld computer 502c, and cellular telephone 502d are illustrated as being in communication with LAN 504 via a wireless connection, while desktop computer 502b is illustrated as being in communication with LAN 504 via a wired connection. Exemplary communication mediums for communication with LAN 504 include telephone line or “dial-up” connections, cable, DSL, Ethernet, Wireless High-Fidelity (i.e., “Wi-Fi” or IEEE standard 802.11), or the like.

Client device 502 may be configured to communicate with network device 506 via LAN 504 using one of several types of communications protocols and/or formats. Preferably, system 500 is configured such that client device 502 communicates website requests to server 509 via LAN 504 using HTTP and suitable Internet browser software (e.g., Internet Explorer, Opera, Firefox, etc.), which may also be utilized to facilitate viewing web pages received by client device 502. Client device 502 may be configured to establish communication with LAN 504 using any suitable technique. For example, client device 502 may be configured to establish communication with LAN 504 by sending a DHCP request to a DHCP server associated with LAN 504, wherein the DHCP server is configured to respond to the DHCP request with various IP addresses for devices associated with LAN 504, such as an IP address for client device 502, a network subnet mask associated with the LAN, a DNS server associated with the LAN, a gateway associated with the LAN, etc.

LAN 504 is generally configured to facilitate communication between client device 502 and network device 506. More particularly, LAN 504 is configured to facilitate the transmission of a DNS request associated with a website request for server 508 from client device 502 to network device 506, and to facilitate the transmission of web pages from server 509 to client device 502 in response to the website request. According to an exemplary embodiment, LAN 504 is configured to facilitate the transmission of DNS requests associated with website requests for server 508 from client device 502 to network device 506, and the transmission of web pages from server 509 to client device 502 in response to the website request for all website requests. According to another exemplary embodiment, LAN 504 is configured to facilitate the transmission of DNS requests associated with website requests for server 508 from client device 502 to network device 506, and the transmission of web pages from server 508 to client device 502 in response to the website request whenever client device 502 is allowed access to or is in authorized communication with server 508, such as after completing an authentication process.

As with LAN 104 (shown in FIG. 1) access to LAN 504 is limited to an approximate geographic area 512 that is relatively smaller in size, as opposed to a WAN that links two or more networks to cover a large geographic area (e.g., the Internet or World Wide Web or another network linking several cities, states, countries, etc.). For example, according to various exemplary embodiments, LAN 504 may be accessible to users in the approximate geographic area of an entity such as a sports facility 530, a real estate location 532, a business, university or organizational facility 534, a historical site 536, a golf course 538, a park 540, or the like. According to various other embodiments, LAN 504 may be interconnected with one or more additional LANs to form a MAN providing access to a town or city 542.

Network device 506 may be one of several types of network devices. According to an exemplary embodiment, network device 506 is a DNS server configured to respond to DNS requests from client device 502 using a particular network device protocol. An exemplary configuration for network device 506 is as follows:

Compaq DeskPro EN ATX Desktop computer;

RedHat Linux 7.2 Server;

ISC BIND 9;

ISC BIND Zone file configuration: @ IN A ip-addr;

Network Card 1: LAN;

Network Device 506 is generally configured to receive and process DNS requests associated with website requests for server 508 from client device 502 via LAN 504. More particularly, network device 506 is configured to respond to the DNS request with the IP address for server 509 so that the website request is redirected to server 509 regardless of the originally requested URL. For example, network device 506 is configured to redirect a website request from client device 502 for a website hosted by server 508 to server 509.

Servers 508 and 509 are host servers associated with different websites which include information in the form of one or more web pages. Server 508 is optionally in communication with server 509. Network 510 may be of any suitable configuration. According to an exemplary embodiment, network 510 is a WAN such as the Internet or an Intranet.

Server 509 is in communication with client device 502 via network 511. Network 511 may be of any suitable configuration to connect server 509 with client device 502. According to an exemplary embodiment, network 511 is a WAN such as the Internet or an Intranet. According to another exemplary embodiment, network 511 is a part of LAN 504 or another LAN or MAN. Server 509 is configured to receive redirected website requests transmitted from client device 502, and to transmit a web page to client device 502 via LAN 504.

According to an exemplary embodiment, the web page or pages provided by server 509 include content that is associated with the approximate geographic area 512 having access to LAN 504. For example, the content may be information or an advertisement provided by an entity located in approximate geographic area 512. According to an exemplary embodiment, LAN 504 is accessible to users in the approximate geographic area 512 of sports facility 530, such as an auto or horse racing track, football or baseball stadium, etc. In this embodiment, the web pages provided by server 509 include information or advertisements targeted to users of LAN 504, such as information on wagering, statistics on competitors or teams, scores and highlights, live video feeds and instant replays, or advertisements and information for various concessions available.

According to another exemplary embodiment, LAN 504 is accessible to users in the approximate geographic area 512 of real estate location 532. In this embodiment, the web pages provided by server 509 include information targeted to users of LAN 504, such as information on the property (e.g., listing price, square footage and other specifications of the property, inspection reports, home features, etc.), photographs of the interior, video clips and “virtual tours,” information on associated real estate agents or brokers, etc.

According to another exemplary embodiment, LAN 504 is accessible to users in the approximate geographic area 512 of historical site 536. In this embodiment, the web pages provided by server 509 include information targeted to users of LAN 504, such as information on the history of the site, maps of site, points of interest, etc.

According to another exemplary embodiment, LAN 504 is accessible to users in the approximate geographic area 512 of golf course 538. In this embodiment, the web pages provided by server 509 include information targeted to users of LAN 504, such as information on players in a tournament, live video feeds of players at the various holes throughout the course, tournament statistics and updates, maps of the course and hole and par information, etc.

According to another exemplary embodiment, LAN 504 is accessible to users in the approximate geographic area 512 of park 540, such as a national park. In this embodiment, the web pages provided by server 509 include information targeted to users of LAN 504, such as information and maps for the park, self-guided wireless tours, etc.

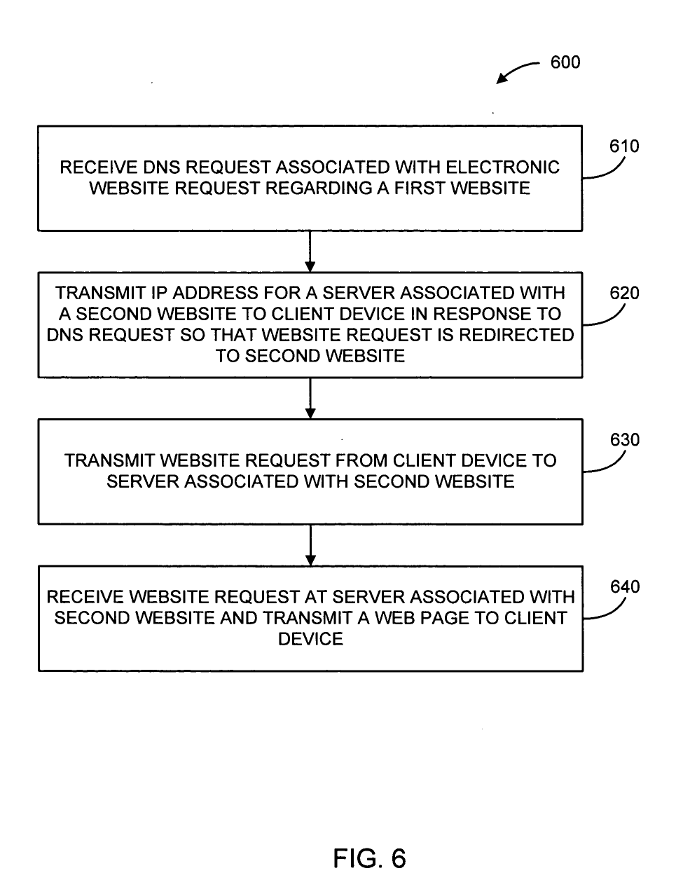

FIG. 6 is a flow diagram illustrating a method 600 of processing a website request using system 500 according to an exemplary embodiment. Method 600 begins with a step 610. In step 610, a DNS request associated with an electronic website request regarding a website hosted by server 508 is sent from client device 502 and received by network device 506. In a step 620, network device 506 responds to the DNS request by transmitting the IP address for server 509 to client device 502 which redirects the website request from client device 502 to a website hosted by server 509. Server 509 is associated with a website different from the requested website hosted by server 508 and may include one or more web pages having content associated with an approximate geographic area 512 having access to LAN 504. In a step 630, client device 502 transmits the website request to server 509 using the IP address for server 509 received from network device 506. In a step 640 the website request is received by server 509, and a web page is transmitted from server 509 to client device 502.

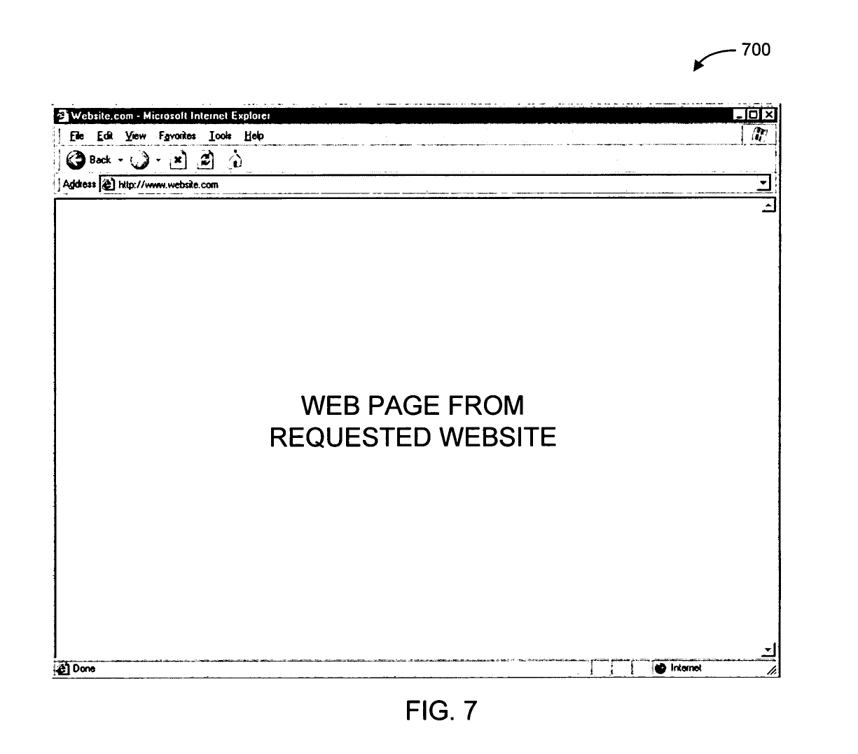

FIG. 7 illustrates the content of a web page 700 corresponding to a requested website before using method 600 to redirect the website request according to an exemplary embodiment. The content included in web page 700 is that which would be provided by the server hosting the requested website (e.g., server 508 shown in FIG. 5), which is shown as http://www.website.com/, assuming that the server hosting the website is accessible.

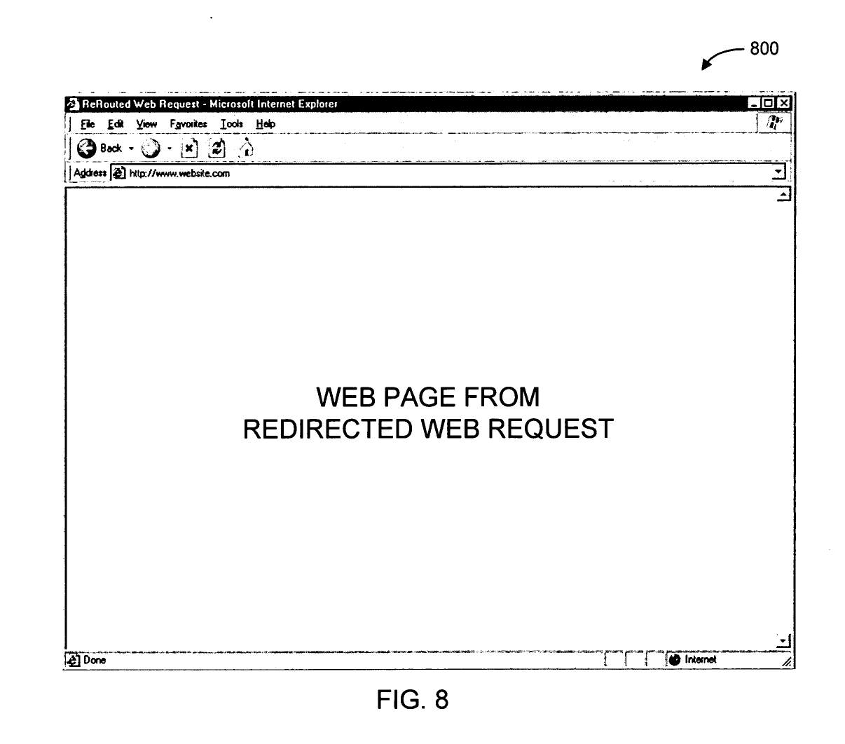

FIG. 8 illustrates the content of a web page 800 provided in response to the web request after using method 600 to redirect the website request according to an exemplary embodiment. As shown in FIG. 8, the requested website URL is still shown as http://www.website.com/. However, the actual content is not that which would be provided by the server hosting the requested website (e.g., server 508 shown in FIG. 5). The actual content is from a web page provided by server 509 that may include content that is associated with the approximate geographic area 512 having access to LAN 504.

In this way, the method and apparatus for processing a website request provides local geographical management of web page content by allowing all clients having access to LAN 504 to view a single designated web page as a default home page regardless of the requested website. Various entities may provide information or advertisements using server 509 and network device 506 such that LAN 504 functions as a localized, specialized network. Because users of LAN 504 are physically located in an approximate geographic area having access to LAN 504, these entities may target information, advertisements, etc. to the particular local market or limited geographic area and limit usage of LAN 504 to a particular localized purpose.

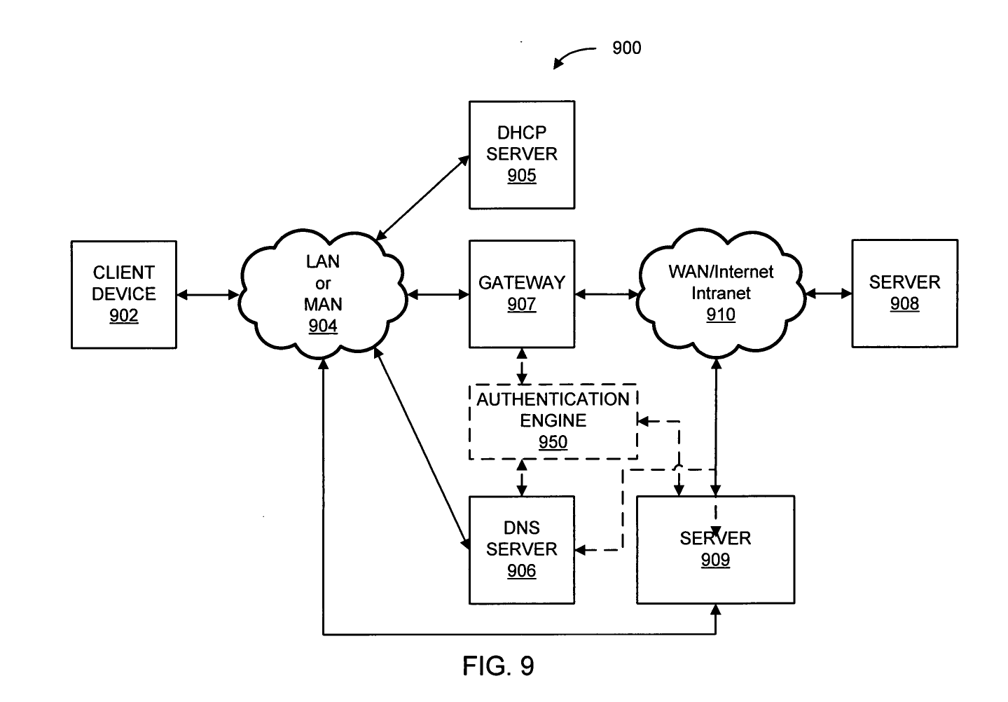

FIG. 9 is a diagram illustrating a system 900 which is an embodiment of system 500 in which exemplary methods of processing a website request may be implemented. In system 900, one or more client devices 902 are in communication with a LAN 904. LAN 904 is in communication with a DHCP server 905, a DNS server 906, which is an embodiment of network device 506, and a gateway 907. Gateway 907 is in communication with server 908 via network 910. System 900 optionally includes authentication engine 950, which is shown in communication with DNS server 906, gateway 907, and server 909. System 900 is generally configured to receive a DNS request associated with a website request for server 908 from a client device 902 in communication with DNS server 906 via LAN 904, and to transmit a web page from server 909 to client device 902 in response to the website request. More particularly, system 900 is configured to redirect the website request to server 909 by responding to the associated DNS request with the IP address of server 909 rather than server 908, and to transmit a web page from server 909 to client device 902 in response to the website request. System 900 is optionally configured to include an authentication engine or other system for allowing or denying access to server 908.

Client device 902 may be one of several types of microprocessor-based devices configured for communication with DNS server 906 via LAN 904 and having appropriate display capabilities as described above with regard to client device 502. Client device 902 may also be configured to communicate with LAN 904 using a wired or wireless communication connection, and may also be configured to communicate with DNS server 906 via LAN 904 using one of several types of communications protocols and/or formats as described above. Client device 902 may be configured to establish communication with LAN 904 using any suitable technique. For example, client device 902 may be configured to establish communication with LAN 904 by sending a DHCP request to DHCP server 905, wherein DHCP server 905 is configured to respond to the DHCP request with IP addresses for client device 902, network subnet masks for client device 902, DNS server 906, gateway 907, etc.

LAN 904 is generally configured to facilitate communication between client device 902 and DHCP server 905, DNS server 906, and gateway 907. More particularly, LAN 904 is configured to facilitate the transmission of a DNS request associated with a website request for server 908 from client device 902 to DNS server 906, to facilitate the transmission of an IP address from DNS server 906 to client device 902 in response to the DNS request, and to facilitate the transmission of web pages from server 909 (or optionally server 908 via server 909) to client device 902 in response to the website request. As with LAN 504 (shown in FIG. 5), access to LAN 904 is limited to an approximate geographic area that is relatively smaller in size, as opposed to a WAN that links two or more networks to cover a large geographic area (e.g., the Internet or World Wide Web or another network linking several cities, states, countries, etc.). According to various embodiments, LAN 904 may be interconnected with one or more additional LANs to form a MAN providing access to a town or city as described above.

DNS Server 906 is in communication with LAN 904 either directly, via network 910, or both directly and via network 910. DNS server 906 is generally configured to receive and process DNS requests associated with website requests received from client device 902 via LAN 904, so that web pages received from server 909 (or optionally server 908 via server 909) may be transmitted to the client device 902 in response to the website request. Typical DNS systems operate in a distributed database environment where multiple DNS servers are in communication with each other to complete a domain name system. Beginning at the root or top-level domains, each DNS server may be authoritative for a number of domains or zones. To complete a distributed domain name system, current DNS servers may be non-authoritative for at least one or more zones. During a typical DNS request, a DNS server may determine whether it is authoritative or non-authoritative for the given domain or zone. When authoritative, a typical DNS server may return the known IP address to the client device issuing the DNS request. When non-authoritative, a typical DNS server may return the known IP address to the client device issuing the DNS request after having issued its own DNS request to the root or authoritative server for the given domain name or zone. According to an exemplary embodiment, DNS server 906 is configured to be authoritative for every possible domain or zone for client device 902.

Servers 908 and 909 are host servers associated with different websites which include information in the form of one or more web pages. Server 908 is optionally in communication with gateway 907 via network 910. Network 910 may be of any suitable configuration to connect server 908 with gateway 907. According to an exemplary embodiment, network 910 is a WAN such as the Internet or an Intranet.

Server 909 is in communication with LAN 904 either directly, via network 910, or both directly and via network 910. Server 909 is configured to receive website requests transmitted from client device 902 (e.g., a website request redirected by DNS server 906 from server 908 to server 909), and to transmit a web page to client device 902 via LAN 904 either directly or routed via network 910 and gateway 907.

As with server 509 (shown in FIG. 5) the web page or pages provided by server 909 may include content that is associated with the approximate geographic area having access to LAN 904 according to various exemplary embodiments. For example, the content may be information or an advertisement provided by an entity located in approximate geographic area. Accordingly, the geographic web page applications described above with reference to server 509 are also generally applicable to server 909. According to an exemplary embodiment, server 909 may also contain web pages used as part of an authentication process.

Authentication engine 950, which is shown as being optionally in communication with DNS server 906, gateway 907, and server 909, is generally configured to facilitate the selective redirection of a web request received from client device 902 to server 909. For example, in the illustrated embodiment, authentication engine 950 is optionally in communication with DNS server 906 and server 909 so that if the user of client device 902 has successfully completed an authentication process, DNS server 906 responds to a DNS request associated with a request for a website hosted by server 908 from client device 902 with the IP address for server 909. Client device 902 then initiates a website request to server 909 for a website associated with server 908. Server 909 is able to communicate with server 908, initiate a website request to server 908 by translating the website request from client device 902 to the URL for server 908 (i.e., HTTP header or virtual hosts), obtain a response from server 908, and transmit the response to client device 902. If the user of client device 902 has not successfully completed the authentication process, DNS server 906 responds to the DNS request with the IP address for server 909. Client device 902 then initiates a website request to server 909 for a website associated with server 908, wherein server 909 responds to the website request from client device 902 with a web page associated with server 909. In the illustrated embodiment, authentication engine 950 is optionally in communication with a firewall associated with gateway 907 to block access to server 908 if the user of client device 902 has not successfully completed an authentication process such as by blocking particular IP addresses or hardware (i.e., MAC) addresses. In the illustrated embodiment, authentication engine 950 is also in communication with server 909 to access an interface for the authentication process, such as web pages used as part of the authentication process (e.g., a login screen, etc.). Preferably, authentication engine 950 is not in communication with DHCP server 905. By avoiding the use of DHCP server 905 to manipulate network lease times, unnecessary network traffic caused by dropping and reconnecting unauthenticated users from system 900 may be avoided.

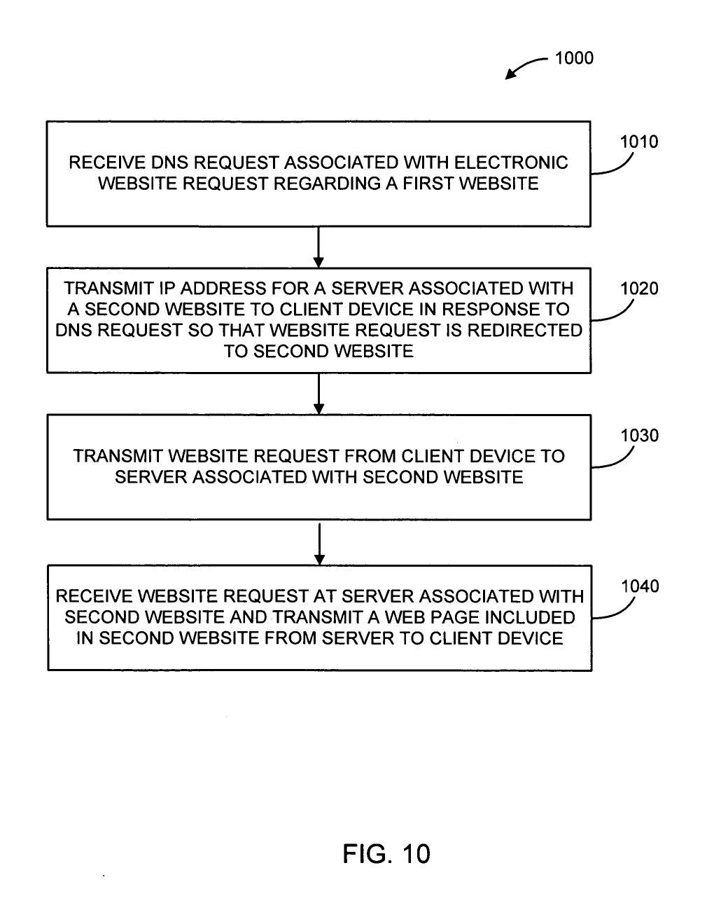

FIG. 10 is a flow diagram illustrating a method 1000 of processing a website request using system 900 according to an exemplary embodiment, wherein optional authentication engine 950 is not utilized, wherein server 909 is part of LAN 904, and wherein DNS server 906 is configured to redirect all web requests received from client device 902 to server 909. In this embodiment, DNS server 906 allows system 900 to operate without being in communication with any additional DNS servers or other networks (e.g., the Internet) because the IP address for server 909 is the only IP address needed. Method 1000 begins with a step 1010. In step 1010, a DNS request associated with a website request regarding a website hosted by server 908 is sent from client device 902 and received by DNS server 906. In a step 1020, DNS server 906 responds to the DNS request by transmitting the IP address for server 909 to client device 902 which redirects the website request from client device 902 to a website hosted by server 909. Server 909 is associated with a website different from the requested website hosted by server 908 may include one or more web pages having content associated with an approximate geographic area having access to LAN 904. In a step 1030, client device 902 transmits the website request to server 909 using the IP address for server 909 received from DNS server 906. In a step 1040 the website request is received by server 909, and one of the web pages included in the website hosted by server 909 is transmitted from server 909 to client device 902.

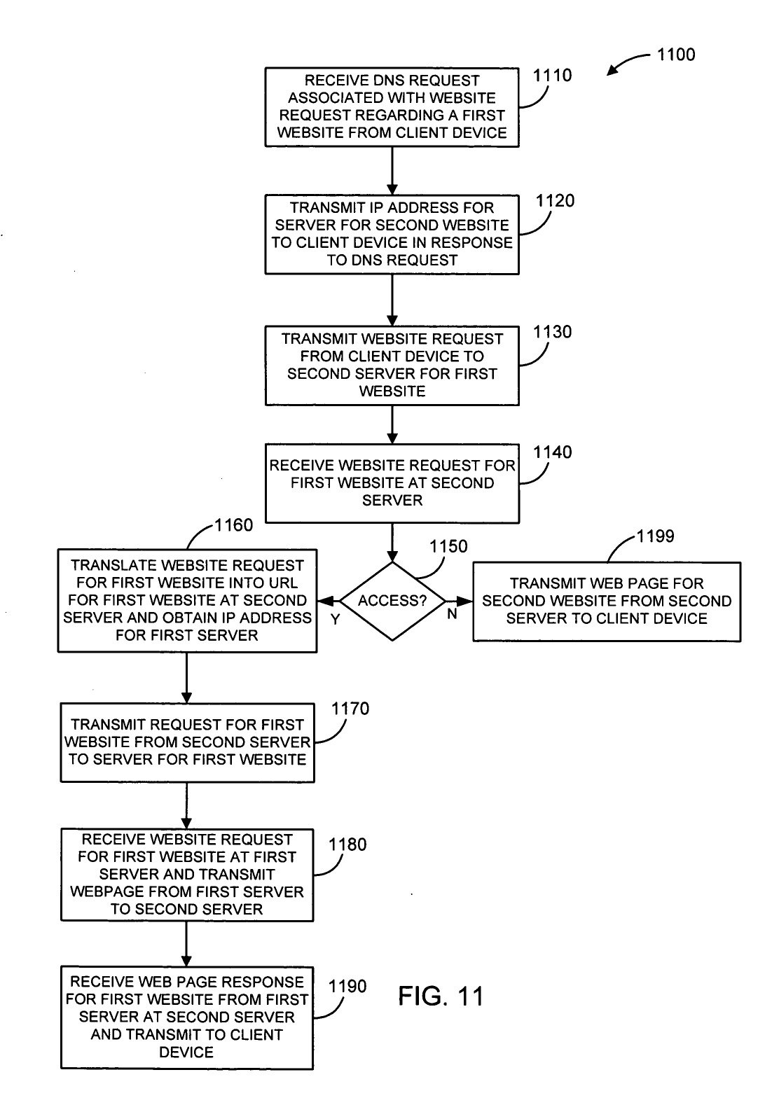

FIG. 11 is a flow diagram illustrating a method 1100 of processing a website request using system 900 according to another exemplary embodiment, wherein optional authentication engine 950 is not utilized, wherein network device 906 is configured to redirect website requests from client device 902 for a website hosted by server 908 to server 909, and wherein server 909 is configured to selectively return content from server 909 or server 908 depending on whether access is generally allowed to server 908. Method 1100 begins with a step 1110. In step 1110, a DNS request associated with a website request regarding a website hosted by server 908 is sent from client device 902 and received by DNS server 906. In a step 1120, DNS server 906 responds to the DNS request by transmitting the IP address for server 909 to client device 902. In a step 1130, client device 902 transmits the website request for server 908 to server 909 via LAN 904 (and optionally via gateway 907) using the IP address for server 909 received from DNS server 906. In a step 1140, the website request for server 908 is received by server 909 from client device 902. In a step 1150, server 909 determines whether access to server 908 is generally allowed by system 900. If access to server 908 is generally allowed, the method continues with a step 1160, in which server 909 translates the website request from client 902 for server 908 to obtain the URL address for server 908 and obtains the IP address for server 908 via the authoritative DNS server of the domain associated with the translated URL. In a step 1170, server 909 transmits a website request to server 908 for the translated URL address via network 910 (and optionally via gateway 907). In a step 1180, server 908 receives a website request from server 909 and responds to server 909 with the requested web page. In a step 1190, server 909 receives the web page response from server 908 and transmits the web page to client device 902 via LAN 904 (and optionally via gateway 907).

If access is not allowed, the method continues with a step 1199, in which server 909 responds to the website request for server 908 by transmitting one of the web pages included in the website hosted by server 909 to client device 902 via LAN 904 (and optionally via gateway 907). Server 909 is associated with a website different from the requested website and may include, for example, one or more web pages having content associated with an approximate geographic area having access to LAN 904.

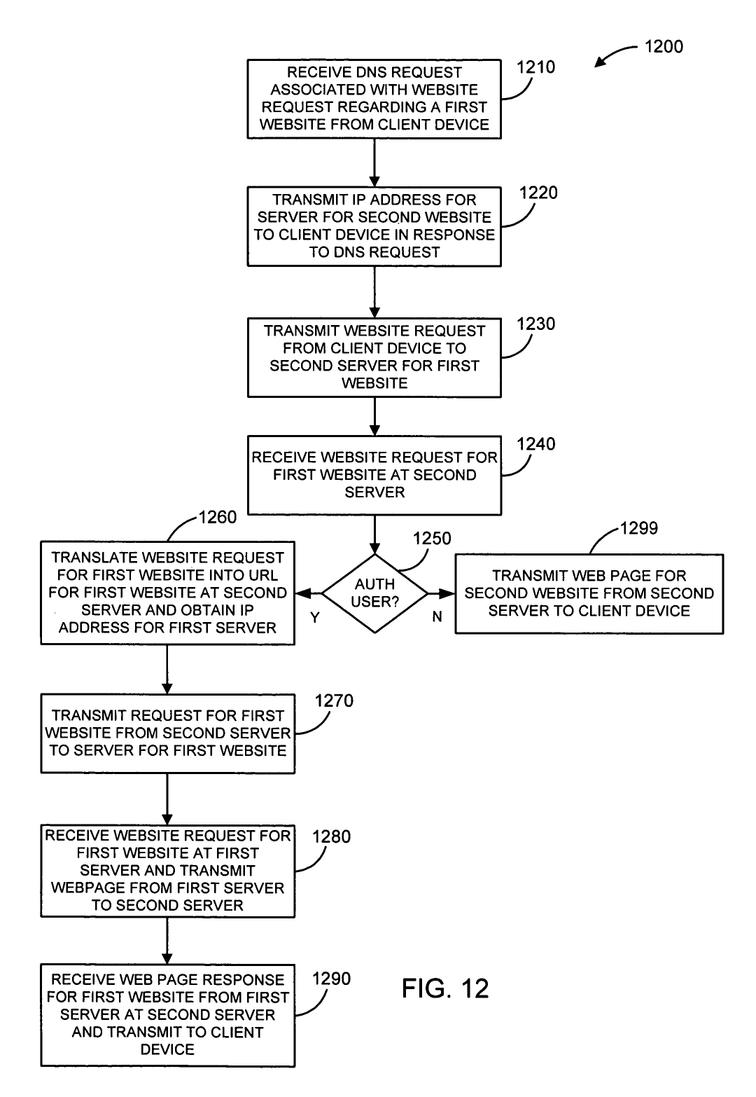

FIG. 12 is a flow diagram illustrating a method 1200 of processing a website request using system 900 according to another exemplary embodiment, wherein optional authentication engine 950 is utilized, wherein network device 906 is configured to redirect website requests from client device 902 for a website hosted by server 908 to server 909, and wherein server 909 is configured to selectively return content from server 909 or server 908 depending on whether the user has successfully completed an authentication process. Upon redirection to server 909, users that have not successfully completed the authentication process may be presented with, for example, a login screen for completing the authentication process, or may receive web pages related to other applications as described above with reference to servers 509 and 909.

Method 1200 begins with a step 1210. In step 1210, a DNS request associated with a website request regarding a website hosted by server 908 is sent from client device 902 and received by DNS server 906. In a step 1220, DNS server 906 responds to the DNS request by transmitting the IP address for server 909 to client device 902. In a step 1230, client device 902 transmits the website request for server 908 to server 909 via LAN 904 (and optionally via gateway 907) using the IP address for server 909 received from DNS server 906. In a step 1240, the website request for server 908 is received by server 909 from client device 902. In a step 1250, server 909 determines whether the user of client device 902 has successfully completed an authentication process and whether the time limit of the user's session has expired. If the user of client device 902 has already successfully completed the authentication process and the time limit of the user's session has not expired, the method continues with a step 1260, in which server 909 translates the website request from client 902 for server 908 to obtain the URL address for server 908 and obtains the IP address for server 908 via the authoritative DNS server of the domain associated with the translated URL. In a step 1270, server 909 transmits a website request to server 908 for the translated URL address via network 910 (and optionally via gateway 907). In a step 1280, server 908 receives the website request from server 909 and responds to server 909 with the requested web page. In a step 1290, server 909 receives the web page response from server 908 and transmits the web page to client device 902 via LAN 904 (and optionally via gateway 907).

If the user of client device 902 has not already successfully completed the authentication process or the time limit of the user's session has expired, the method continues with a step 1299, in which server 909 responds to the website request for server 908 by transmitting one of the web pages included in the website hosted by server 909 to client device 902 via LAN 904 (and optionally via gateway 907). Server 909 is associated with a website different from the requested website and may include, for example, one or more web pages having content associated with an approximate geographic area having access to LAN 904. Server 909 may also contain web pages used as part of the authentication process (e.g., a login screen, etc.). As described above, a firewall associated with gateway 907 is used in conjunction with authentication engine 950 to block access to server 908 if the user of client device 902 has not successfully completed the authentication process, such as by blocking particular IP addresses or hardware (i.e., MAC) addresses.

As described above, DNS server 906 and web server 909 are used in system 900 for redirecting web requests received from client device 902, and for selectively returning requested content. In addition to allowing system 900 to redirect web requests in several embodiments without being in communication with any additional DNS servers or other networks (e.g., the Internet), the use of a DNS server in system 900 may also allow for redirecting web requests without reconfiguring client device 902. The use of a DNS server and a web server in system 900 for redirecting web requests may also reduce system CPU power requirements in some systems because a proxy server is not required to translate client requests from unauthenticated clients. The use of a DNS server in a system for redirecting web requests may also allow for more efficient implementation of new types of user authentication interfaces. New types of user authentication interfaces may be implemented by reconfiguring the server used for the authentication interfaces, and without the need to establish a new proxy for redirection to the server.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

What is claimed is:

1. A method, comprising:
receiving an electronic website request regarding a website, wherein the website request is received by a network device in communication with a Local Area Network (LAN) from a client device in communication with the LAN;
transmitting the website request from the network device to a server associated with the website;
receiving a web page from the server associated with the website in response to the website request, wherein the web page is received by the network device;
modifying the web page within the network device to include additional content associated with an approximate geographic area having access to the LAN; and
transmitting the modified web page from the network device to the client device.

2. The method of claim 1, wherein the additional content is provided by an entity located in the approximate geographic area.

3. The method of claim 2, wherein the additional content comprises an advertisement.

4. The method of claim 2, wherein the additional content comprises information regarding the entity.

5. The method of claim 2, wherein the entity is a provider of at least one of products and services.

6. The method of claim 1, wherein transmitting the request and receiving the web page comprise transmitting the request and receiving the web page via the Internet.

7. The method of claim 1, wherein the LAN is part of a Metropolitan Area Network (MAN).

8. A method, comprising:
receiving a Domain Name System (DNS) request associated with an electronic website request regarding a first website, wherein the DNS request is received by a DNS server in communication with a Local Area Network (LAN) from a client device in communication with the LAN;
redirecting the website request to a server associated with a second website different from the first website by transmitting an Internet Protocol (IP) address for the server associated with the second website from the DNS server to the client device in response to the DNS request; wherein the DNS server is configured to respond to all DNS requests by transmitting the IP address for the server associated with the second website, and
transmitting a web page included in the second website from the server associated with the second website to the client device in response to the redirected website request.

9. The method of claim 8, wherein the second website includes a web page including content associated with an approximate geographic area having access to the LAN.

10. The method of claim 8, wherein the content is provided by an entity located within the approximate geographic area.

11. The method of claim 10, wherein the content comprises an advertisement.

12. The method of claim 10, wherein the content comprises information regarding the entity.

13. The method of claim 10, wherein the entity is a provider of at least one of products and services.

14. The method of claim 10, wherein the approximate geographic area having access to the LAN is a real estate location, and wherein the content comprises information regarding the real estate location.

15. The method of claim 8, wherein transmitting the website request and transmitting web page comprise transmitting the request and transmitting the web page via the Internet.

16. The method of claim 8, wherein the LAN is part of a Metropolitan Area Network (MAN).

17. A network device configured to process an electronic request regarding a website, comprising:
means for receiving the electronic request regarding the website from a client device in communication with a Local Area Network (LAN), wherein the network device is in communication with the LAN;
means for transmitting the request to a server associated with the website;
means for receiving a web page from the server associated with the website in response to the request;
means for modifying the web page to include additional content associated with an approximate geographic area having access to the LAN; and
means for transmitting the modified web page to the client device.

18. A Domain Name System (DNS) server configured to process an electronic request regarding a website, comprising:
means for receiving a DNS request associated with an electronic website request regarding a first website, wherein the DNS request is received from a client device in communication with the DNS server via a LAN; and
means for redirecting the website request to a server associated with a second website different from the first website by transmitting an Internet Protocol (IP) address for the server associated with the second website from the DNS server to the client device in response to the DNS request; wherein the DNS server is configured to respond to all DNS requests by transmitting the IP address for the server associated with the second website.

19. The DNS server of claim 18, wherein the second website includes a web page including content associated with an approximate geographic area having access to the LAN.

20. The DNS server of claim 19, wherein the approximate geographic area having access to the LAN is a real estate location, and wherein the content comprises information regarding the real estate location.

21. A method, comprising:
receiving an electronic website request regarding a first website, wherein the website request is received by a network device in communication with a Local Area Network (LAN) from a client device in communication with the LAN;
redirecting the website request to a server associated with a second website different from the first website; wherein the network device is configured to redirect all website requests to the server associated with the second website; and
transmitting a web page included in the second website from the server associated with the second website to the client device in response to the redirected website request; wherein the content of the web page includes content associated with an approximate geographic area having access to the LAN.

22. The method of claim 21, wherein the approximate geographic area having access to the LAN is a real estate location, and wherein the content comprises information regarding the real estate location.
